(19) United States
(12) Patent Application Publication
(10) Pub. No.: US 2019/0056423 A1
(43) Pub. Date: Feb. 21, 2019

(54) ADJOINT ANALYSIS METHOD AND APPARATUS FOR DATA

(71) Applicant: Alibaba Group Holding Limited, Grand Cayman (KY)

(72) Inventors: Xianshu DING, Hangzhou (CN); Yi LUO, Hangzhou (CN); Lu HAN, Hangzhou (CN); Linqiang WU, Hangzhou (CN)

(21) Appl. No.: 16/078,278

(22) PCT Filed: Mar. 16, 2017
(86) PCT No.: PCT/CN2017/076875

§ 371 Date: Aug. 21, 2018

(30) Foreign Application Priority Data
Mar. 25, 2016 (CN) 201610179784.8

(51) Int. Cl. G01P 13/02

(52) U.S. Cl. CPC G01P 13/02

(57) ABSTRACT

The disclosed embodiments provide an adjoint analysis method and apparatus for data. A dimensionality reduction processing is performed on two-dimensional spatial data in original data of a target number to obtain one-dimensional spatial data of the target number; the one-dimensional spatial data of the target number and time data in the original data are converted into a comparable trajectory queue of the target number; and an adjoint similarity between the target number and other numbers is calculated based on the trajectory queue of the target number. In the present invention, the original data is simplified through the dimensionality reduction processing; fitting processing is no longer performed through a mathematic model, which reduces complexity and improves timeliness of the adjoint analysis.

### CROSS-REFERENCE TO RELATED APPLICATION

This present application claims priority to Chinese Patent Application No. 201610179784.8, filed on 25 Mar. 2016 titled “ADJOINT ANALYSIS METHOD AND APPARATUS FOR DATA” and Int'l Appl. No. PCT/CN2017/076875, filed on Mar. 16, 2017 and titled “METHOD AND DEVICE FOR ANALYZING DATA SIMILARITY,” both of which are incorporated by reference herein in their entirety.

### BACKGROUND

### Technical Field

The present disclosure relates to the field of data processing, analysis, and calculation, and in particular, to an adjoint analysis method and apparatus for data.

### Description of the Related Art

In mobile big data, there exists a great deal of useful positioning data. To mine this useful positioning data in the mobile big data, it is possible to obtain a trajectory consisting of locations traversed by a target number within a certain time period using an adjoint analysis for numerical data. Then the trajectory of the target number is compared with trajectories of other numbers, and the adjoint similarity between these numbers is calculated. The adjoint similarity can be a very favorable basis for improving the relevance judgement among numbers.

Data density of mobile big data is very high, and the timeliness of the adjoint analysis for numerical data is more demanding in interactive applications. Currently, trajectory fitting needs to be performed first and adjoint similarity between numbers is then calculated. Because the original data used to describe trajectories of numbers has a large discrete deviation amplitude, a complicated nonlinear mathematical model needs to be established to perform the fitting process, which is complicated and time-consuming.

### BRIEF SUMMARY

The disclosed embodiments provide an adjoint analysis method and apparatus for data, used to solve the problems of high complexity and time-consuming in current techniques where a trajectory fitting is performed first, followed by the calculating of the adjoint similarity.

To achieve the above objective, the present invention provides an adjoint analysis method for data, the method comprising: reducing the dimensionality of two-dimensional spatial data in original data of a target number to obtain one-dimensional spatial data of the target number; converting the one-dimensional spatial data of the target number and time data into a comparable trajectory queue of the target number; and calculating an adjoint similarity between the target number and other numbers based on the trajectory queue of the target number.

To achieve the above objective, the present invention provides an adjoint analysis apparatus for data, the apparatus comprising: a dimensionality reduction module, configured to perform a dimensionality reduction processing on two-dimensional spatial data in original data of a target number to obtain one-dimensional spatial data of the target number; a data conversion module, configured to convert the one-dimensional spatial data of the target number and time data into a comparable trajectory queue of the target number; and a calculation module, configured to calculate an adjoint similarity between the target number and other numbers based on the trajectory queue of the target number.

In the adjoint analysis method and apparatus for data provided in the present invention, a dimensionality reduction processing is performed on two-dimensional spatial data in original data of a target number to obtain one-dimensional spatial data of the target number; the one-dimensional spatial data of the target number and time data are converted into a comparable trajectory queue of the target number; and an adjoint similarity between the target number and other numbers is calculated based on the trajectory queue of the target number. In the present invention, the original data is simplified through the dimensionality reduction processing; fitting processing is no longer performed through a mathematic model, which reduces complexity and improves timeliness of the adjoint analysis.

### BRIEF DESCRIPTION OF THE DRAWINGS

FIG. 1 is a flow diagram illustrating an adjoint analysis method for data according some embodiments of the disclosure.

FIG. 2 is a flow diagram illustrating an adjoint analysis method for data according some embodiments of the disclosure.

FIG. 3 is a flow diagram illustrating an adjoint analysis method for data according some embodiments of the disclosure.

FIG. 4 is a flow diagram illustrating an adjoint analysis method for data according some embodiments of the disclosure.

FIG. 5 is a block diagram illustrating an adjoint analysis apparatus for data according some embodiments of the disclosure.

FIG. 6 is a block diagram illustrating an adjoint analysis apparatus for data according some embodiments of the disclosure.

### DETAILED DESCRIPTION

The adjoint analysis method and apparatus for data provided by the disclosed embodiments are described in detail below with reference to the accompanying drawings.

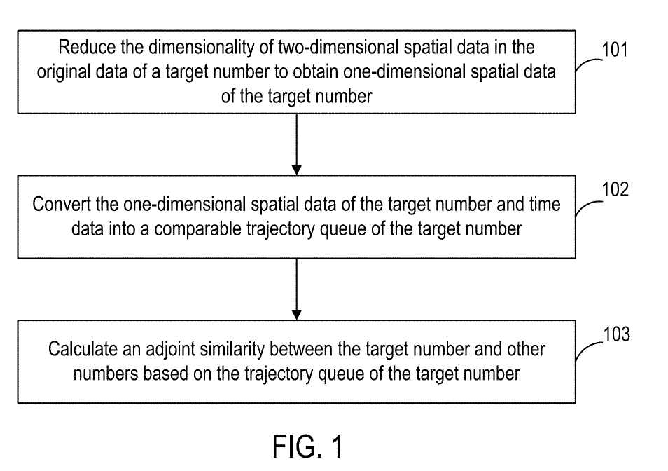

FIG. 1 is a flow diagram illustrating an adjoint analysis method for data according some embodiments of the disclosure. The adjoint analysis method for data includes the following steps.

S101: Reduce the dimensionality of two-dimensional spatial data in original data of a target number to obtain one-dimensional spatial data of the target number.

In the process of a moving number, a lot of positioning data is generated. Generally, this positioning data includes data used to show spatial dimensions of location information and data used to show the time dimension of time. Of them, the spatial dimension data is composed of longitude and latitude data. In this embodiment, the positioning data generated in the number moving process is defined as original data, and the original data may represent locations of the number at different times.

To reduce the dimensionality of the original data and simplify the positioning data, in this embodiment, dimensionality reduction is performed on two-dimensional spatial data in the original data of the target number to obtain the one-dimensional spatial data. Specifically, a spatial hashing processing is performed on the two-dimensional spatial data of the target number, i.e., the longitude and latitude data; and the two-dimensional spatial data is mapped into one-dimensional geohash encoding. That is, the longitude and latitude are sequentially iteratively mapped to 32-ary encoding. In this embodiment, the one-dimensional geohash encoding is the one-dimensional spatial data of the target number; and in this case, the geohash encoding can be used to show the location of the target number.

S102: Convert the one-dimensional spatial data of the target number and time data into a comparable trajectory queue of the target number.

After the two-dimensional spatial data in the original data is converted into the one-dimensional spatial data, the corresponding time data does not change. After the one-dimensional spatial data of the target number is obtained, it is combined with time data in the original data corresponding to the one-dimensional spatial data to form trajectory records of the target number. In this embodiment, the trajectory records of the target number can represent locations of the target number at different time points. The time points correspond to the time data in the original data. The locations are shown by using one-dimensional spatial data.

The trajectory records of the target number are records of time points. To compare data of the target number, further, data normalization needs to be performed on the trajectory records of the target number to obtain trajectory queues of the target number. That is, a recording method of the trajectory records of the target number is converted from time points to a recording method of time periods.

S103: Calculate an adjoint similarity between the target number and other numbers based on the trajectory queue of the target number.

After the trajectory queue of the target number is obtained, the same process may be performed for obtaining a trajectory queue of other numbers. Then, the trajectory queue based on the target number is compared with the trajectory queue of other numbers. An adjoint similarity between the target number and other numbers is obtained based on a preset adjoint similarity strategy. In this embodiment, other numbers may be one or more. Optionally, other numbers may be inputted by a user, or may be numbers with similar trajectories inquired according to the target number.

In the adjoint analysis method for data provided in the embodiments, a dimensionality reduction processing is performed on two-dimensional spatial data in original data of a target number to obtain one-dimensional spatial data of the target number; the one-dimensional spatial data of the target number and time data are converted into a comparable trajectory queue of the target; and an adjoint similarity between the target number and other numbers is calculated based on the trajectory queue of the target number. In the embodiment, the original data is simplified through the dimensionality reduction processing; fitting processing is no longer performed through a mathematic model, which reduces complexity and improves timeliness of the adjoint analysis.

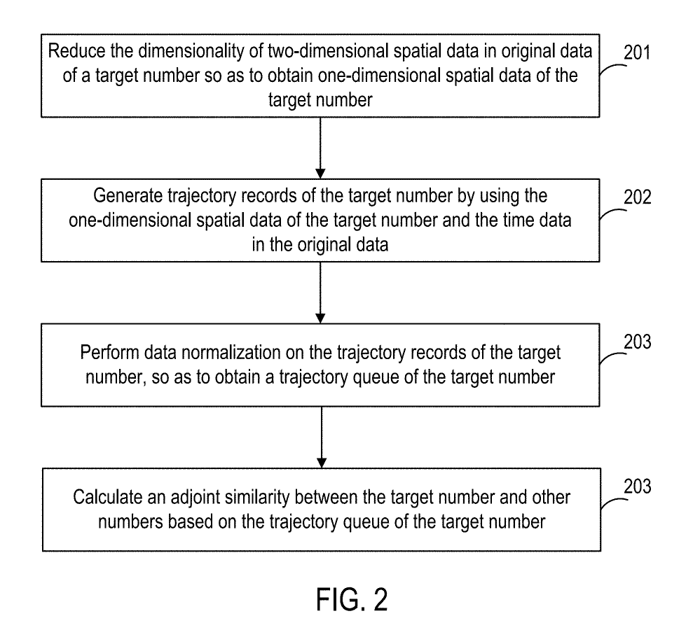

FIG. 2 is a flow diagram illustrating an adjoint analysis method for data according some embodiments of the disclosure. The adjoint analysis method for data includes the following steps.

S201: Reduce the dimensionality of two-dimensional spatial data in original data of a target number to obtain one-dimensional spatial data of the target number.

To reduce the dimensionality of the original data and simplify the positioning data, in this embodiment, dimensionality reduction is performed on two-dimensional spatial data of the original data of the target number to obtain the one-dimensional spatial data. Specifically, a spatial hashing processing is performed on the two-dimensional spatial data of the target number, i.e., the longitude and latitude data; and the two-dimensional spatial data is mapped into one-dimensional geohash encoding. That is, the longitude and latitude are sequentially iteratively mapped to 32-ary encoding. In this embodiment, the one-dimensional geohash encoding is the one-dimensional spatial data of the target number; and in this case, the geohash encoding can be used to show the location of the target number.

S202: Generate trajectory records of the target number by using the one-dimensional spatial data of the target number and the time data in the original data.

After the two-dimensional spatial data in the original data is converted into the one-dimensional spatial data, the corresponding time data does not change. After the one-dimensional spatial data of the target number is obtained, it is combined with time data in the original data corresponding to the one-dimensional spatial data to form trajectory records of the target number. In this embodiment, the trajectory records of the target number can represent locations of the target number at different time points. The time points correspond to the time data in the original data. The locations are shown by using one-dimensional spatial data.

S203: Perform data normalization on the trajectory records of the target number, to obtain a trajectory queue of the target number.

The trajectory records of the target number are records of time points. To compare data of the target number, further, data normalization needs to be performed on the trajectory records of the target number to obtain a trajectory queue of the target number. That is, a recording method of the trajectory records of the target number is converted from time points to a recording method of time periods.

Specifically, for a record having continuous time points locating at the same location in the trajectory record of the target number, using a time point showing the earliest time as a start time of the same location, and using a time point showing the latest time as an end time of the same location, to obtain a trajectory corresponding to the same location. The target number is at the same location at continuous time points, which indicates that the target number is at the same location and remains in the same location within the time period. In actual applications, the original data has great data intensity and cannot be directly processed. In this embodiment, records having the same location are combined based on time points; and duplicate records may be removed first, which simplifies the processing of the data.

For a record having different time points locating at different locations in the trajectory record of the target number, using the time points as start times and end times of the different locations to obtain trajectories corresponding to the different locations.

After the record format of time points is converted into the record format of time periods, the time periods of trajectories are not continuous. To compare the trajectories of the target number, a serialization processing needs to be performed on the discontinuous time periods. Specifically, digits of the geohash encoding in each record of the trajectory queue are adjusted to preset digits; and then adjustment needs to be performed on endpoints of the time periods of the trajectory, to establish a comparable trajectory queue of the target number. First, all trajectories of the target number are sorted from the earliest start time to the most recent start time; endpoints of the time periods of adjacent trajectories in the target number are adjusted so that the endpoints of the time periods of the adjacent trajectories overlap. After the adjustment to the endpoints of the time periods of all the trajectories is completed, the trajectory queue of the target number is obtained. In this embodiment, the endpoints of the time period are the start time and end time of the time period. For example, the upper endpoint of the time period of the current trajectory, i.e., the start time, is an intermediate value between the end time of the previous trajectory and the start time of this current trajectory; and the lower endpoint of the time period of the current trajectory, i.e., the end time, is an intermediate value between the end time of this current trajectory and the start time of the next trajectory. For example, the lower endpoint of the time period of the current trajectory remains unchanged; and the upper endpoint value of the time period of the next trajectory is adjusted to be the upper endpoint of the time period of the current trajectory, so that endpoints of the time periods of adjacent trajectories overlap.

The examples below explain S101 to S103.

A target number is 155****2623, and the original data of the number is as follows:

155****2623 150406 184822 121.83593 30.06664

155****2623 150406 185058 121.83593 30.06664

155****2623 150406 184513 121.83523 30.06364

155****2623 150406 193049 121.83593 30.06364

155****2623 150406 182333 121.84594 30.06164

155****2623 150406 182545 121.87593 30.06164

After S101 and S102, trajectory records of the target number are as follows:

155****2623 150406 184822 wtqej57qg

155****2623 150406 185222 wtqej57qg

155****2623 150406 184513 wtqej37qg

155****2623 150406 184622 wtqej37qg

155****2623 150406 193049 wtqej56qg

155****2623 150406 182333 wtqej90qg

155****2623 150406 182545 wtqej23qg

During the processing in S103, the trajectories of the target number are as follows:

155****2623 150406184822-150406185222 wtqej57qg

150406184513-150406184622 wtqej37qg

150406193049-150406193049 wtqej56qg

150406182333-150406182333 wtqej90qg

150406182545-150406182545 wtqej23qg

Normalization needs to be performed on the first queue of the target number. Some digits of the geohash encoding are discarded according to preset digits; and then the endpoints of the time periods of adjacent trajectories are adjusted, so that adjacent records are continuous on the time periods. The trajectory queue of the target number is as follows:

155****2623 150406182333-150406182439 wtqej90 1con1

150406182439-150406183544 wtqej23 1con2

150406183544-150406184722 wtqej37 1con3

150406184722-150406191135 wtqej57 1con4

150406191135-150406193049 wtqej56 1con5

S204: Calculate an adjoint similarity between the target number and other numbers based on the trajectory queue of the target number.

After the trajectory queue of the target number is obtained, the same process may be performed for obtaining a trajectory queue of other numbers. Then, the trajectory queue based on the target number is compared with the trajectory queue of other numbers. An adjoint similarity between the target number and other numbers is obtained based on a preset adjoint similarity strategy. In this embodiment, other numbers may be one or more. Optionally, other numbers may be inputted by a user, or may be numbers with similar trajectories inquired according to the target number.

The process of calculating, based on a preset adjoint similarity calculation strategy, the adjoint similarity between the target number and the other numbers includes dividing the geohash encoding of the preset digits first based on geography and by default, different weights for each level are set; and comparing each record in the trajectory queue of the target number with each record of the other numbers and determining whether intersections in time between two records being compared exist. If an intersection in times exists, it indicates that the time periods have overlapping time. For example, when the start time of a record of the target number is within a time period range of a record of other numbers, it indicates that these two are overlapped in time.

In this embodiment, when an intersection in times exists, duplicate levels between geohash encodings showing the locations in the two compared records are obtained; preset weights corresponding to the duplicate levels are then obtained. Multiplying the preset weights with a preset intersection base value to obtain an intersection value. After obtaining the number of intersections in time and intersection values of the intersections are obtained, a ratio of the sum of all the intersection values to the number of intersections is obtained, which is then used as the adjoint similarity between the target number and the other numbers. In this embodiment, instead of using the three-dimensional Euclidean distance to obtain the adjoint similarity, the preset adjoint analysis strategy is used to obtain the adjoint similarity, thereby reducing the computing complexity and improving the efficiency of the adjoint analysis.

For example, when the geohash encoding is chosen to be kept for seven bits, the 5th, 6th, and 7th bits in the coding are set to be included in the calculation of the adjoint similarity. A setting rule for the weights may be: the base value is set to 1 when an intersection exists. If the seven bits of geohash coding are the same, the weight is 1; if the first 6 bits of geohash coding are the same but the 7th bit is different, the weight is 0.5; if the first five bits of geohash coding are the same but the 6th bit is different, the weight is 0.25; if the first five bits of geohash are different, or if there is no intersection in time, the weight is 0. A calculation formula of the adjoint similarity is: a sum of all the intersection data/the number of intersections in time.

In the adjoint analysis method for data provided in the embodiments, a dimensionality reduction processing is performed on two-dimensional spatial data in original data of a target number to obtain one-dimensional spatial data of the target number; the one-dimensional spatial data of the target number and time data of the original data are used as the trajectory records of the target number, which are converted into a comparable trajectory queue of the target number by using a data rule; and the adjoint similarity between the target number and other numbers is calculated based on the trajectory queue of the target number. In the embodiment, the original data is simplified through the dimensionality reduction processing; fitting processing is no longer performed through a mathematic model, which reduces complexity and improves timeliness of the adjoint analysis.

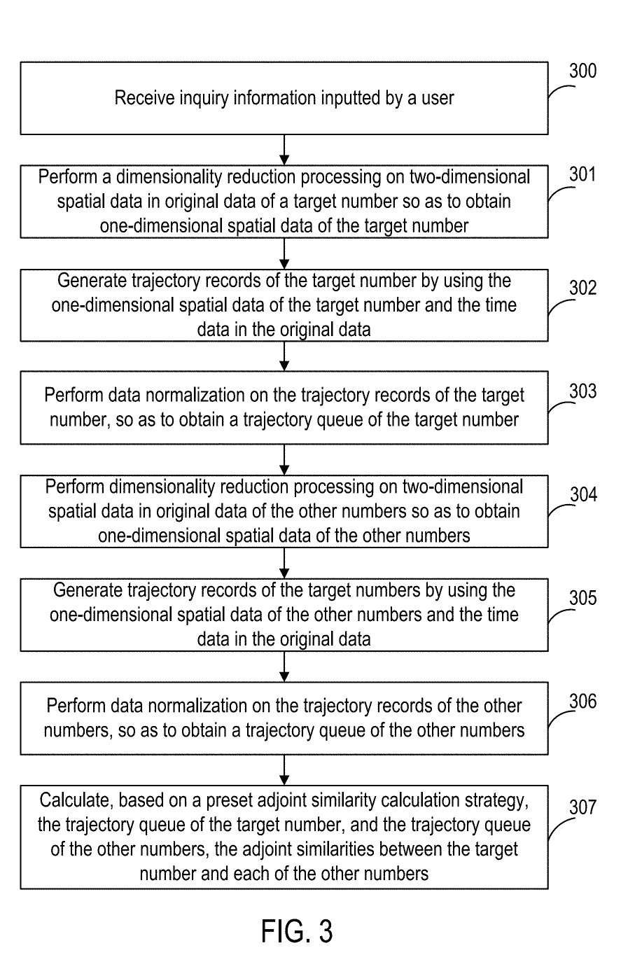

As shown in FIG. 3, a flow diagram of an adjoint analysis method for data according some embodiments of the disclosure is illustrated. The adjoint analysis method for data includes the following steps.

S300: Receive inquiry information inputted by a user.

The inquiry information includes an inquiry number and an inquiry time period, the quantity of the inquiry number being one (1), and the inquiry number being used as the target number.

When a user attempts to perform adjoint analysis on the target number, the user may input inquiry information through an inquiry interface, wherein the inquiry information includes an inquiry number and an inquiry time period. The quantity of the inquiry number may be one or more. In this embodiment, a known target number and other numbers compared with the target number are used as an application scenario for explanation. In this application scenario, one of the inquiry numbers is used as the target number; and the rest of the inquiry numbers are used as other numbers. The other numbers are all compared with the target number; no comparison is performed between the target numbers.

S301: Reduce the dimensionality of two-dimensional spatial data in original data of a target number to obtain one-dimensional spatial data of the target number.

S301 is executed after the inquiry information inputted by the user is received. For specific content of S301, reference may be made to the description of S101 in FIG. 1 and details are not provided herein but are incorporated by reference in their entirety.

S302: Generate trajectory records of the target number by using the one-dimensional spatial data of the target number and the time data in the original data.

The trajectory record of the target number is configured to record locations of the target number at different time points; the time points correspond to time data in the original data; and the locations are shown using one-dimensional spatial data.

S303: Perform data normalization on the trajectory records of the target number, to obtain a trajectory queue of the target number.

The trajectory queue of the target number is configured to record locations of the target number in different time periods, and the time periods are generated using the time points in the trajectory records of the target number.

S304: Reduce the dimensionality of two-dimensional spatial data in original data of the other numbers to obtain one-dimensional spatial data of the other numbers.

S305: Generate trajectory records of the target numbers by using the one-dimensional spatial data of the other numbers and the time data in the original data.

S306: Perform data normalization on the trajectory records of the other numbers, to obtain trajectory queues of the other numbers.

The steps S301 to S303 for processing the target number are used to process the other numbers, to obtain trajectory queues of the other numbers. For the specific process, reference may be made to the description of the relevant content in the above embodiment; and details are not provided herein but are incorporated by reference in their entirety. S301 to S303 may be performed synchronously with S304 to S306; or S301 to S303 may be performed first, followed by S304 to S306.

S307: Calculate, based on a preset adjoint similarity calculation strategy, the trajectory queue of the target number, and the trajectory queue of the other numbers, the adjoint similarities between the target number and each of the other numbers.

Each record in the trajectory queue of the target number is compared with each record of the other numbers; and the adjoint similarities between the target number and each of the other numbers are calculated based on a preset adjoint similarity calculation strategy. For the adjoint similarity calculation strategy, reference may be made to the description of the relevant content in the above embodiment; and details are not provided herein but are incorporated by reference in their entirety.

To better understand the adjoint analysis method for data provided in this embodiment, in what follows a specific example is used for illustration.

The inquiry information inputted by the user includes an inquiry number, wherein the inquiry number includes a target number and other numbers to be compared with the target number. In this example, the inquiry information carries two inquiries with the target number being the inquiry number 1 (ID1), and the other to-be-compared number being the inquiry number 2 (ID2): ID1: 155****2623; ID2: 150****8803; inquiry time period (Time): 2015-04-01_00:00:00-2015-04-06_23:59:59

All the original data of ID1 in the period of 2015-04-01_00:00:00-2015-04-06_23:59:59 includes:

155****2623 150406 184822 121.83593 30.06664

155****2623 150406 185058 121.83593 30.06664

155****2623 150406 184513 121.83523 30.06364

155****2623 150406 193049 121.83593 30.06364

155****2623 150406 182333 121.84594 30.06164

155****2623 150406 182545 121.87593 30.06164

All the original data of ID2 in the period of 2015-04-01_00:00:00-2015-04-06_23:59:59 includes:

150****8803 150406 195323 121.83516 30.06264

150****8803 150406 195308 121.83504 30.02664

150****8803 150406 195239 121.83583 30.06064

150****8803 150406 135325 121.83572 30.06264

150****8803 150406 104159 121.83543 30.16364

150****8803 150406 064003 121.83598 30.06663

150****8803 150406 064003 121.83598 30.06663

Dimensionality reduction is performed on two-dimensional data in the original data of the inquiry number to obtain one-dimensional spatial data; and then the one-dimensional spatial data and the time data in the original data are used to generate the trajectory records of the inquiry number.

The trajectory records of ID1 are as follows:

155****2623 150406 184822 wtqej57qg

155****2623 150406 185222 wtqej57qg

155****2623 150406 184513 wtqej37qg

155****2623 150406 184622 wtqej37qg

155****2623 150406 193049 wtqej56qg

155****2623 150406 182333 wtqej90qg

155****2623 150406 182545 wtqej23qg

The trajectory records of ID2 are as follows:

150****8803 150406 195323 wtqej27qg

150****8803 150406 195623 wtqej27qg

150****8803 150406 195308 wtqej87qg

150****8803 150406 195239 wtqej87qg

150****8803 150406 135325 wtqej37qg

150****8803 150406 104159 wtqej72qg

150****8803 150406 064003 wtqej45qg

Data deduplication and sparse processing are performed on the trajectory records of the inquiry number to obtain a trajectory of the inquiry number. Specifically, the process of performing data deduplication and sparse processing on the trajectory record of the inquiry number includes combining records having continuous time points locating in the same location; using a time point showing the earliest time as the start time of the location and using a time point showing the most recent time as the end time of the location. For records of different locations, the time points corresponding to the locations are used as the start times and the end times of the corresponding time periods; that is, the start time and the end time of the time period may be the same.

The same data deduplication and sparse processing process are performed on the trajectory records of ID1, and the trajectories of ID1 are obtained as follows:

101221 155****2623 150406184822-150406185222 wtqej57qg

150406184513-150406184622 wtqej37qg

150406193049-150406193049 wtqej56qg

150406182333-150406182333 wtqej90qg

150406182545-150406182545 wtqej23qg

The same data deduplication and sparse processing process are performed on the trajectory records of ID2, and the trajectories of ID2 are obtained as follows:

150****8803 150406195323-150406195623 wtqej27qg

150406195239-150406195308 wtqej87qg

150406135325-150406135325 wtqej37qg

150406104159-150406104159 wtqej72qg

150406064003-150406064003 wtqej45qg

The geohash encoding of each trajectory of the target number is adjusted to preset bits; the trajectory of the target number is sorted; and endpoints of the time periods of the trajectory are adjusted, so that the endpoints of the time periods of two adjacent trajectories can overlap, to obtain a trajectory queue of the inquiry number. Specifically, the sorting is done from the earliest start time to the most recent start time; and the adjustment is performed on the endpoints of the time periods of the adjacent trajectories according to the sorting result. For example, intermediate values of the end time of the former period and the end time of the next period are respectively used as the end time of the previous period and the start time of the next period, so that the endpoints of the time periods of the adjacent trajectories can overlap to form a comparable trajectory queue.

The trajectory queue of ID1 is as follows:

155****2623 150406182333-150406182439 wtqej90 1con1

150406182439-150406183544 wtqej23 1con2

150406183544-150406184722 wtqej37 1con3

150406184722-150406191135 wtqej57 1con4

150406191135-150406193049 wtqej56 1con5

The trajectory queue of ID2 is as follows:

150****8803 150406064003-150406084101 wtqej45 2con1

150406084101-150406121712 wtqej72 2con2

150406121712-150406165302 wtqej37 2con3

150406165302-150406195315 wtqej87 2con4

150406195315-150406195623 wtqej27 2con5

The adjoint similarity between two inquiry numbers is calculated based on a preset adjoint similarity calculation strategy.

The geohash encoding can be kept for seven bits, wherein the 5th, 6th, and 7th bits in the coding are to be included in the calculation of the adjoint similarity. First, it is determined whether an intersection in times exists; for example, if the start time of 1con1 is within the time period range of 2conN, then 1con1 has an intersection in times with 2conN.

Different duplicate bits correspond to different weights; and the set intersection base value is 1. If the seven bits of geohash coding are the same, the weight is 1; if the first 6 bits of geohash coding are the same but the 7th bit is different, the weight is 0.5; if the first five bits of geohash coding are the same but the 6th bit is different, the weight is 0.25; if the first five bits of geohash are different, or if there is no intersection in time, the weight is 0.

1con1 is compared with 2con1 to 2con5; 1con1 and 2con1 , 2con2, 2con3, and 2con5 have no intersections in time; 1con1 and 2con4 have an intersection in time; the first five bits of geohash encoding are the same, but the 6th bit is different; and the intersection value=1*0.25.

Similarly, 1con2 is compared with 2con1 to 2con5; 1con2 and 2con1, 2con2, 2con3, and 2con5 have no intersections in time; 1con2 and 2con4 have an intersection in time; the first five bits of geohash encoding are the same, but the 6th bit is different; and the intersection value=1*0.25.

1con3 is compared with 2con1 to 2con5; 1con3 and 2con1, 2con2, 2con3, and 2con5 have no intersections in time; 1con3 and 2con4 have an intersection in time; the first five bits of geohash encoding are the same, but the 6th bit is different; and the intersection value=1*0.25.

1con4 is compared with 2con1 to 2con5; 1con4 and 2con1, 2con2, 2con3, and 2con5 have no intersections in time; 1con4 and 2con4 have an intersection in time; the first five bits of geohash encoding are the same, but the 6th bit is different; and the intersection value=1*0.25.

1con5 is compared with 2con1 to 2con5; 1con5 and 2con1, 2con2, 2con3, and 2con5 have no intersections in time; 1con5 and 2con4 have an intersection in time; the first five bits of geohash encoding are the same, but the 6th bit is different; and the intersection value=1*0.25.

The adjoint similarity between the target number and the other number is (+1*0.25+ . . . +1*0.25)/(the number of intersections in time)=0.25.

In the above example, a user may specify two numbers for comparison. After data dimensionality reduction is performed on two-dimensional spatial data, one-dimensional spatial data is obtained. Then a comparable trajectory queue is formed based on the one-dimensional spatial data and the time data; and a preset adjoint similarity calculation strategy is used to obtain the adjoint similarity between the two numbers.

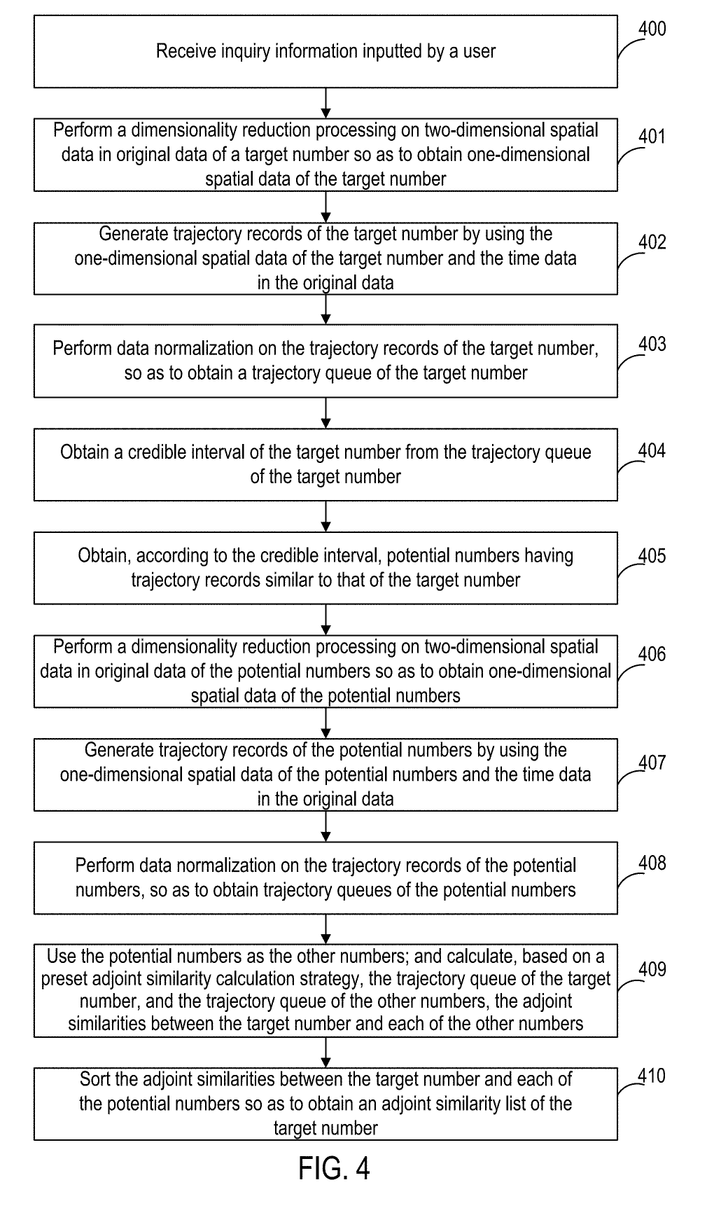

As shown in FIG. 4, a flow diagram of an adjoint analysis method for data according some embodiments of the disclosure is illustrated. The adjoint analysis method for data includes the following steps.

S400: Receive inquiry information inputted by a user.

The inquiry information includes an inquiry number and an inquiry time period, the quantity of the inquiry number being one, and the inquiry number being used as the target number.

When a user attempts to perform adjoint analysis on the target number, the user may input inquiry information through an inquiry interface, wherein the inquiry information includes an inquiry number, an inquiry time period, and the quantity of returned potential numbers similar to the target number. In this embodiment, an application scenario of obtaining, through the target number, the potential number having a similar trajectory with the target number is used as an example. In this case, the quantity of the inquiry number is one (1), and in this application scenario, the inquiry number is used as a target number.

S401: Reduce the dimensionality of two-dimensional spatial data in original data of a target number to obtain one-dimensional spatial data of the target number.

S401 is executed after the inquiry information inputted by the user is received. For specific content of 401, reference may be made to the description of S101 in FIG. 1; and details are not provided herein but are incorporated by reference in their entirety.

S402: Generate trajectory records of the target number by using the one-dimensional spatial data of the target number and the time data in the original data.

The trajectory record of the target number is configured to record locations of the target number at different time points; the time points correspond to time data in the original data and the locations are shown using one-dimensional spatial data.

S403: Perform data normalization on the trajectory records of the target number, to obtain a trajectory queue of the target number.

The trajectory queue of the target number is configured to record locations of the target number in different time periods, and the time periods are generated using the time points in the trajectory records of the target number.

For specific contents of S302 to S303, reference may be made to the descriptions of S102 to S103 in FIG. 1 above; and details are not provided herein but are incorporated by reference in their entirety.

S404: Obtain a credible interval of the target number from the trajectory queue of the target number.

In this embodiment, the trajectory queue of the target number is used for recording locations of the target number in different time periods; and a credible interval of the target number may be obtained according to the trajectory queue of the target number. The credible interval includes a credible time domain and a credible spatial domain. The credible time domain includes time periods of each record in the trajectory queue. A specific process of the credible spatial domain includes: correcting thresholds of locations in each record of the trajectory queue and using the corrected locations as the credible spatial domain. For example, the first five bits that are the same in geohash encoding of each location are used as the credible spatial domain. For example, the first five bits in geohash encoding represents Beijing, and adding four more to the five bits may represent specific districts/villages within Beijing. To ensure credibility of the space, the first five bits in geohash encoding are used as the credible spatial domain.

S405: Obtain, according to the credible interval, potential numbers having trajectory records similar to that of the target number.

After obtaining the credible interval, according to the credible interval of the target number in the inquiry time period, potential numbers having trajectory records similar to that of the target number are searched.

S406: Perform a dimensionality reduction processing on two-dimensional spatial data in original data of the potential numbers to obtain one-dimensional spatial data of the potential numbers.

S407: Generate trajectory records of the potential numbers by using the one-dimensional spatial data of the potential numbers and the time data in the original data.

S408: Perform data normalization on the trajectory records of the potential numbers, to obtain trajectory queues of the potential numbers.

The steps S401 to S403 for processing the target number are used to process the potential numbers, to obtain trajectory queues of the potential numbers. For the specific process, reference may be made to the description of the relevant content in the above embodiment; and details are not provided herein but are incorporated by reference in their entirety.

S409: Use the potential numbers as the other numbers and calculate, based on a preset adjoint similarity calculation strategy, the trajectory queue of the target number, and the trajectory queue of the other numbers, the adjoint similarities between the target number and each of the other numbers.

After the potential numbers are obtained, the potential numbers are used as the other numbers. Each record in the trajectory queue of the target number is compared with each record of the other numbers; and the adjoint similarities between the target number and each of the other numbers are calculated based on a preset adjoint similarity calculation strategy.

For the adjoint similarity calculation strategy, reference may be made to the description of relevant content in the above embodiment; and details are not provided herein but are incorporated by reference in their entirety.

S410: Sort the adjoint similarities between the target number and each of the potential numbers to obtain an adjoint similarity list of the target number.

After the adjoint similarities between the target number and each of the potential numbers are obtained, the adjoint similarities are sorted in a descending order to obtain an adjoint similarity list of the target number. In this embodiment, the first few are selected from all the sorted adjoint similarities to generate the adjoint similarity list of the target number.

To better understand the adjoint analysis method for data provided in this embodiment, in what follows a specific example is used for illustration.

The inquiry information inputted by a user includes an inquiry number: 155****2623; the inquiry time period: Time: 2015-04-01_00:00:00-2015-04-06_23:59:59; the quantity of the potential numbers similar to the target number is returned: TopN: 3, wherein the inquiry number is the target number.

The original data record of the target number within the inquiry time period include:

155****2623 150406 184822 121.83593 30.06664

155****2623 150406 184513 121.83523 30.06364

155****2623 150406 193049 121.83593 30.06364

155****2623 150406 182333 121.84594 30.06164

155****2623 150406 182545 121.87593 30.06164

After dimensionality reduction and data normalization are performed on the target number, the trajectory queue of the target number ID can be seen as follows. Reference may be made to the description of the relevant examples in FIG. 2 for the process of performing dimensionality reduction and data normalization on the target number; and details are not provided herein but are incorporated by reference in their entirety.

155****2623 150406182333-150406182439 wtqej90 1con1

150406182439-150406183544 wtqej23 1con2

150406183544-150406184722 wtqej37 1con3

150406184722-150406191135 wtqej57 1con4

150406191135-150406193049 wtqej56 1con5

The credible interval is obtained from the trajectory queue of the target number, and the credible interval includes a time credible interval and a spatial credible interval; that is, the trajectory queue of the target number includes time periods and locations.

A potential number having a trajectory record similar to that of the target number is obtained according to the credible interval. Specifically, a similar trajectory record of each record 1coni (i=1, 2, 3, . . . 5) in the trajectory queue of the target number is inquired: searching for a similar trajectory; and finding records that have an intersection in times with 1coni and the first five bits of geohash are all the same from the original data.

1con1: 150406182333-150406182439 wtqej90

155****2623 150406 184822 wtqej57qg

151****1306 150406 183539 wtqej31qg

1con2: 150406182439-150406183544 wtqej23

155****2623 150406 182545 wtqej23qg

152****8808 150406 182952 wtqej54qg

1con3: 150406183544-150406184722 wtqej37

155****2623 150406 184513 wtqej37qg

155****2623 150406 184622 wtqej37qg

1528808150406 184112 wtqej31qg

151****1306 150406 184537 wtqej90qg

1con4: 150406184722-150406191135 wtqej57

155****2623 150406 184822 wtqej57qg

152****8808150406 190253 wtqej29qg

152****3889 150406 185742 wtqej46qg

151****1306 150406 191023 wtqej72qg

1con5: 150406191135-150406193049 wtqej56

155****2623 150406 193049 wtqej56qg

152****3889 150406 192516 wtqej36qg

153****5666 150406 191756 wtqej69qg

After the searching is completed, three numbers hit within each record of the target number are used as potential numbers; the potential numbers do not include the target number.

The potential numbers are sorted according to the hit times:

151****1306 four

152****8808 three

152****3889 two

153****5666 one

151****1306, 152****8808, and 152****3889 are selected as potential numbers; and the adjoint similarities between the target number and the selected three potential numbers are respectively calculated. The calculation process is similar to that of calculating the adjoint similarity of two known inquiry numbers in FIG. 2; and details are not provided herein but are incorporated by reference in their entirety.

The adjoint similarities of the target number are sorted; and the first three potential numbers and adjoint similarities are selected to generate an adjoint similarity list of the target number. The list is as follows:

| Number | Similarity |
|---|---|
| 151****1306 | 0.72 |
| 152****8808 | 0.62 |
| 152****3889 | 0.33 |

In this embodiment, a user may specify a target number; search potential numbers having similar trajectories based on the trajectory of the target number and use them as other numbers; use a preset adjoint similarity calculation strategy to obtain an adjoint similarity between the target number and the potential number based on the trajectory queue of the two numbers.

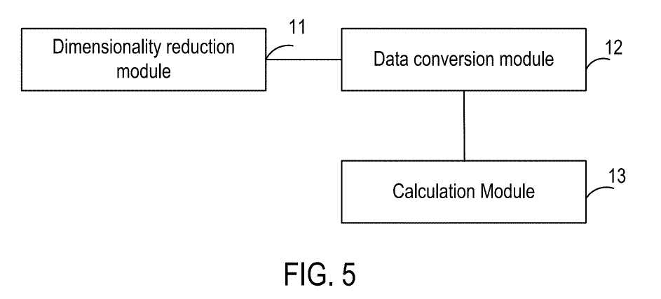

As shown in FIG. 5, a block diagram of an adjoint analysis apparatus for data according some embodiments of the disclosure is illustrated. The adjoint analysis apparatus for data includes a dimensionality reduction module 11, a data conversion module 12, and a calculation module 13.

The dimensionality reduction module 11 is configured to perform a dimensionality reduction processing on two-dimensional spatial data in original data of a target number to obtain one-dimensional spatial data of the target number.

In the process of a moving number, a lot of positioning data is generated. Generally, this positioning data includes data used to show spatial dimension of location information and data used to show the time dimension of time. Of them, the spatial dimension data is composed of longitude and latitude data. In this embodiment, the positioning data generated in the number moving process is defined as original data, and the original data may represent locations of the number at different times.

To reduce the dimensionality of the original data and simplify the positioning data, in this embodiment, the dimensionality reduction module 11 performs the dimensionality reduction on two-dimensional spatial data in the original data of the target number to obtain the one-dimensional spatial data. Specifically, the dimensionality reduction module 11 performs a spatial hashing processing on the two-dimensional spatial data of the target number, i.e., the longitude and latitude data; and the two-dimensional spatial data is mapped into one-dimensional geohash encoding. That is, the longitude and latitude are sequentially iteratively mapped to 32-ary encoding. In this embodiment, the one-dimensional geohash encoding is the one-dimensional spatial data of the target number; and in this case, the geohash encoding can be used to show the location of the target number.

The data conversion module 12 is configured to convert the one-dimensional spatial data of the target number and time data into a comparable trajectory queue of the target number.

Specifically, the data conversion module 12 generates trajectory records of the target number by using the one-dimensional spatial data of the target number and the time data in the original data.

The trajectory record of the target number is configured to record locations of the target number at different time points; the time points correspond to time data in the original data; and the locations are shown using one-dimensional spatial data.

After the two-dimensional spatial data in the original data is converted into the one-dimensional spatial data, the corresponding time data does not change. After the one-dimensional spatial data of the target number is obtained, the data conversion module 12 combines the one-dimensional spatial data with time data in the original data corresponding to the one-dimensional spatial data to form trajectory records of the target number. In this embodiment, the trajectory records of the target number can represent locations of the target number at different time points. The time points correspond to the time data in the original data. The locations are shown by using one-dimensional spatial data.

Further, the data conversion module 12 performs data normalization on the trajectory records of the target number, to obtain a trajectory queue of the target number.

The trajectory queue of the target number is configured to record locations of the target number in different time periods; and the time periods are generated using the time points in the trajectory records of the target number.

The trajectory record of the target number is a record of time points. Further, the data conversion module 12 performs data normalization on the trajectory records of the target number and converts the recording method of the trajectory records of the target number from time points into a recording method of time periods. Specifically, for a record having different time points locating at the same location in the trajectory record of the target number, using a time point showing the earliest time as a start time of the same location, and using a time point showing the latest time as an end time of the same location, to obtain a trajectory corresponding to the same location. In actual applications, the original data has great data intensity and cannot be directly processed. In this embodiment, records having the same location are combined based on time points; and duplicate records may be removed first, which simplifies the processing of the data.

The specific process of the data conversion module 12 performing data normalization on the trajectory records of the target number, to obtain a trajectory queue of the target number is as follows.

For a record having different time points locating at different locations in the trajectory record of the target number, using the time points as start times and end times of the different locations to obtain trajectories corresponding to the different locations.

After the record format of time points is converted into the record format of time periods, the time periods of trajectories are not continuous. To compare the trajectories of the target number, a serialization processing needs to be performed on the discontinuous time periods. Specifically, digits of the geohash encoding in all the trajectories of the target number are adjusted to preset digits; and then adjustment needs to be performed on endpoints of the time periods of the trajectory, to establish a comparable trajectory queue of the target number. First, all trajectories of the target number are sorted from the earliest start time to the most recent start time; endpoints of the time periods of adjacent trajectories in the target number are adjusted so that the endpoints of the time periods of the adjacent trajectories overlap. After the adjustment to the endpoints of the time periods of all the trajectories is completed, the trajectory queue of the target number is obtained. In this embodiment, the endpoints of the time period are the start time and end time of the time period. For example, the upper endpoint of the time period of the current trajectory, i.e., the start time, is an intermediate value between the end time of the previous trajectory and the start time of this current trajectory; and the lower endpoint of the time period of the current trajectory, i.e., the end time, is an intermediate value between the end time of this current trajectory and the start time of the next trajectory. For example, the lower endpoint of the time period of the current trajectory remains unchanged; and the upper endpoint value of the time period of the next trajectory is adjusted to be the upper endpoint of the time period of the current trajectory, so that endpoints of the time periods of adjacent trajectories overlap.

The calculation module 13 is configured to calculate an adjoint similarity between the target number and other numbers based on the trajectory queue of the target number.

After the trajectory queue of the target number is obtained, the same process may be performed for obtaining a trajectory queue of other numbers. Then, the calculation module 13 compares the trajectory queue based on the target number with the trajectory queue of other numbers. An adjoint similarity between the target number and other numbers is obtained based on a preset adjoint similarity strategy. In this embodiment, other numbers may be one or more. Optionally, other numbers may be inputted by a user, or may be numbers with similar trajectories inquired according to the target number.

Regarding the adjoint similarity calculation strategy, reference may be made to the description of relevant content in the above embodiment; and details are not provided herein but are incorporated by reference in their entirety.

In the adjoint analysis apparatus for data provided in the embodiments, a dimensionality reduction processing is performed on two-dimensional spatial data in original data of a target number to obtain one-dimensional spatial data of the target number; the one-dimensional spatial data of the target number and time data of the original data are used as the trajectory records of the target number, which are converted into a comparable trajectory queue of the target number by using a data rule; and the adjoint similarity between the target number and other numbers is calculated based on the trajectory queue of the target number. In the embodiment, the original data is simplified through the dimensionality reduction processing; fitting processing is no longer performed through a mathematic model, which reduces complexity and improves timeliness of the adjoint analysis.

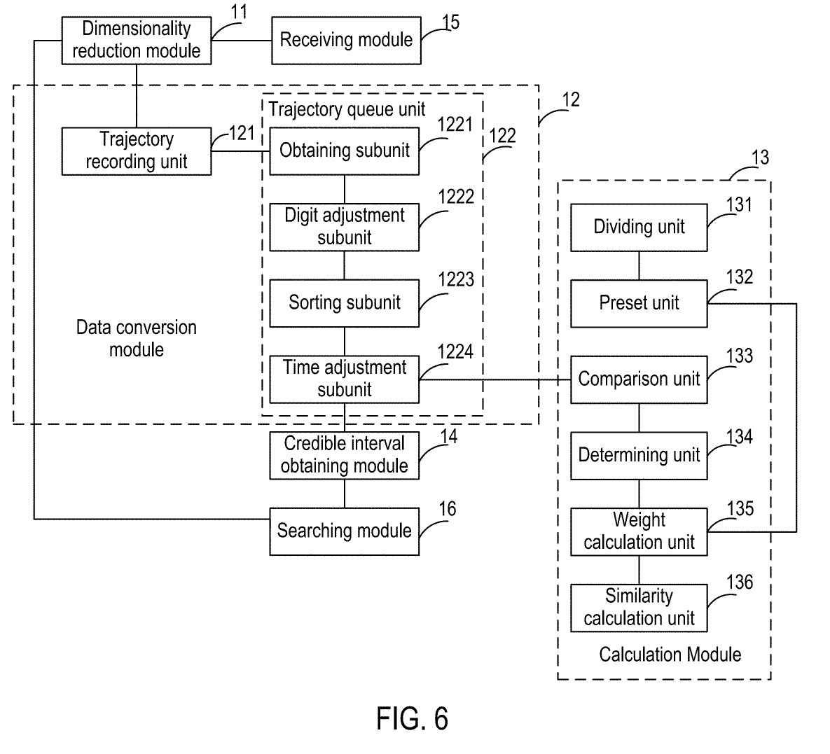

As shown in FIG. 6, a block diagram of an adjoint analysis apparatus for data according some embodiments of the disclosure is illustrated. Other than the dimensionality reduction module 11, the data conversion module 12, and the calculation module 13 in FIG. 4, the adjoint analysis apparatus for data further includes a receiving module 15, a credible interval obtaining module 14, and a searching module 16.

The dimensionality reduction module 11 is configured to perform two-dimensional hashing on the two-dimensional spatial data in the original data to obtain a one-dimensional geohash encoding as the one-dimensional spatial data of the target number.

In this embodiment, an optional structural embodiment of the data conversion module 12 includes a trajectory recording unit 121 and a trajectory queue unit 122.

The trajectory recording unit 121 is configured to generate a trajectory record of the target number through the one-dimensional spatial data of the target number and time data in the original data, the trajectory record of the target number configured to record locations of the target number at different time points, the time points correspond to the time data in the original data, and the locations are shown using the one-dimensional spatial data; and the trajectory queue unit 122 is configured to perform data normalization on the trajectory record of the target number to obtain the trajectory queue of the target number, wherein the trajectory queue of the target number is configured to record locations of the target number in different time periods, and the time periods are generated using time points in the trajectory record of the target number.

In this embodiment, an optional structural embodiment of the trajectory queue unit 122 includes an obtaining subunit 1221, a digit adjustment subunit 1222, a sorting subunit 1223, and a time adjustment subunit 1224.

The obtaining subunit 1221 is configured to do the following: for a record having different time points locating at the same location in the trajectory record of the target number, using a time point showing the earliest time as a start time of the same location, and using a time point showing the latest time as an end time of the same location, to obtain a trajectory corresponding to the same location; for a record having different time points locating at different locations in the trajectory record of the target number, using the time points as start times and end times of the different locations to obtain trajectories corresponding to the different locations;

the digit adjustment subunit 1222 is configured to adjust digits of the geohash encoding in each trajectory of the target number to preset digits;

the sorting subunit 1223 is configured to sort all the trajectories of the target number from the earliest to the latest according to the start times; and

the time adjustment subunit 1224 is configured to adjust endpoints of the time periods of adjacent trajectories in the target number so that the endpoints of the time periods of the adjacent trajectories overlap, to obtain the trajectory queue of the target number.

The receiving module 15 is configured to receive inquiry information inputted by a user, wherein the inquiry information comprises an inquiry number and an inquiry time period, the quantity of the inquiry number being one, and the inquiry number being used as the target number.

The credible interval obtaining module 14 is configured to obtain credible intervals of the target number according to the trajectory queue of the target number.

The searching module 16 is configured to obtain, according to the credible interval, potential numbers having trajectory records similar to that of the target number.

Further, the dimensionality reduction module 11 is configured to perform a dimensionality reduction processing on two-dimensional spatial data in original data of the potential numbers to obtain one-dimensional spatial data of the potential numbers.

The trajectory recording unit 121 is further configured to generate trajectory records of the potential numbers by using the one-dimensional spatial data of the potential numbers and the time data in the original data.

The trajectory queue unit 122 is further configured to perform data normalization on the trajectory records of the potential numbers, to obtain trajectory queues of the potential numbers.

The calculation module 13 is specifically configured to use the potential numbers as the other numbers and calculate, based on the preset adjoint similarity calculation strategy, the adjoint similarities between the target number and each of the other numbers.

The calculation module 13 is further configured to sort the adjoint similarities between the target number and each of the potential numbers to obtain an adjoint similarity list of the target number.

Further, the receiving module 15 is configured to receive inquiry information inputted by a user, wherein the inquiry information comprises an inquiry number and an inquiry time period, the quantity of the inquiry number being at least two (2), using one of the inquiry numbers as the target number, and using the rest of the inquiry numbers as the other numbers.

Further, the dimensionality reduction module 11 is configured to perform a dimensionality reduction processing on two-dimensional spatial data in original data of the potential numbers to obtain one-dimensional spatial data of the potential numbers; the trajectory recording unit 121 is further configured to generate trajectory records of the potential numbers by using the one-dimensional spatial data of the potential numbers and the time data in the original data; the trajectory queue unit 122 is further configured to perform data normalization on the trajectory records of the potential numbers, to obtain trajectory queues of the potential numbers.

The calculation module 13 is specifically configured to calculate, based on the preset adjoint similarity calculation strategy, the adjoint similarities between the target number and each of the other numbers.

In this embodiment, an optional structural embodiment of the calculation module 13 includes a dividing unit 131, a preset unit 132, a comparison unit 133, a determining unit 134, a weight calculation unit 135, and a similarity calculation unit 136.

The dividing unit 131 is configured to divides the geohash encoding of the preset digits based on the geography.

The preset unit 132 is configured to set different weights for each level of the geohash encoding.

The comparison unit 133 is configured to compare each record in the trajectory queue of the target number with each record in the other numbers.

The determining unit 134 is configured to determine whether intersections in time between two records being compared exist.

The weight calculation unit 135 is configured to do the following: if it is determined that intersections in time exist, obtain duplicate levels between the geohash encodings in the two records that are being compared; and obtain intersection values according to the weights corresponding to the duplicate levels and a preset intersection base.

The similarity calculation unit 136 is configured to add all the intersection values and obtaining a ratio of a sum of all the intersection values to the number of intersections and using the ratio as the adjoint similarity between the target number and the other numbers.

In the adjoint analysis apparatus for data provided in the embodiments, a dimensionality reduction processing is performed on two-dimensional spatial data in original data of a target number to obtain one-dimensional spatial data of the target number; the one-dimensional spatial data of the target number and time data of the original data are used as the trajectory records of the target number, which are converted into a comparable trajectory queue of the target number by using a data rule; and the adjoint similarity between the target number and other numbers is calculated based on the trajectory queue of the target number. In the embodiment, the original data is simplified through the dimensionality reduction processing; fitting processing is no longer performed through a mathematic model, which reduces complexity and improves timeliness of the adjoint analysis.

Those skilled in the art can understand that all or part of the steps for implementing the method in above embodiments can be accomplished by hardware related to program instructions. The aforementioned program may be stored in a computer-readable storage medium. In execution, a processor executes the steps of the method in the above embodiments, and the foregoing storage medium includes various medium that can store program instructions, such as a ROM, a RAM, a magnetic disk, or an optical disc.

It should be finally noted that the above embodiments are merely used for illustrating rather than limiting the technical solutions of the present invention. Although the present application is described in detail with reference to the foregoing embodiments, those of ordinary skill in the art should understand that the technical solutions recorded in the foregoing embodiments may still be modified or equivalent replacement may be made on part or all of the technical features therein. These modifications or replacements will not make the essence of the corresponding technical solutions be departed from the scope of the technical solutions in the disclosed embodiments.

1. A method comprising:
reducing a dimensionality of two-dimensional spatial data in original data of a target number to obtain one-dimensional spatial data of the target number;
converting the one-dimensional spatial data of the target number and time data into a comparable trajectory queue of the target number; and
calculating an adjoint similarity between the target number and one or more other numbers based on the trajectory queue.

2. The method of claim 1, the reducing the dimensionality of two-dimensional spatial data in original data comprising performing two-dimensional hashing on the two-dimensional spatial data in the original data to obtain a one-dimensional geohash encoding as the one-dimensional spatial data of the target number.

3. The method of claim 1, the converting the one-dimensional spatial data of the target number and time data comprising:
generating a trajectory record of the target number through the one-dimensional spatial data and time data in the original data, the trajectory record of the target number configured to record locations of the target number at different time points, the time points corresponding to the time data in the original data, and the locations shown using the one-dimensional spatial data; and
performing data normalization on the trajectory record of the target number to obtain the trajectory queue of the target number, the trajectory queue of the target number configured to record locations of the target number in different time periods, and the time periods generated using time points in the trajectory record of the target number.

4. The method of claim 3, the performing data normalization on the trajectory record of the target number to obtain the trajectory queue of the target number comprising:
for a record having continuous time points locating at the same location in the trajectory record of the target number, using a time point showing the earliest time as a start time of the same location, and using a time point showing the latest time as an end time of the same location, to obtain a trajectory corresponding to the same location;
for a record having different time points locating at different locations in the trajectory record of the target number, using the time points as start times and end times of the different locations to obtain trajectories corresponding to the different locations;
sorting the trajectories of the target number from the earliest to the latest according to the start times;
adjusting digits of the geohash encoding in each trajectory of the target number to preset digits; and
adjusting endpoints of the time periods of adjacent trajectories of the target number so that the endpoints of the time periods of the adjacent trajectories overlap, to obtain the trajectory queue of the target number.

5. The method of claim 4, further comprising, prior to the performing a dimensionality reduction processing on original data of a target number to obtain dimensionality reduction data, receiving inquiry information inputted by a user, the inquiry information comprising an inquiry number and an inquiry time period, the quantity of the inquiry number being one, and the inquiry number being used as the target number.

6. The method of claim 5, further comprising, prior to the calculating an adjoint similarity between the target number and one or more other numbers based on the trajectory queue of the target number:
obtaining credible intervals of the target number according to the trajectory queue of the target number;
obtaining, according to the credible interval, potential numbers having trajectory records similar to that of the target number;
reducing the dimensionality of two-dimensional spatial data in original data of the potential numbers to obtain one-dimensional spatial data of the potential numbers;
generating trajectory records of the potential numbers by using the one-dimensional spatial data of the potential numbers and the time data in the original data; and
performing data normalization on the trajectory records of the potential numbers, to obtain trajectory queues of the potential numbers.

7. The method of claim 6, the calculating an adjoint similarity between the target number and one or more other numbers based on the trajectory queue of the target number comprising:
using the potential numbers as the one or more other numbers; and
calculating, based on a preset adjoint similarity calculation strategy, the adjoint similarities between the target number and each of the one or more other numbers.

8. The method of claim 7, further comprising, after the calculating, based on a preset adjoint similarity calculation strategy, the adjoint similarities between the target number and each of the potential numbers, sorting the adjoint similarities between the target number and each of the potential numbers to obtain an adjoint similarity list of the target number.

9. The method of claim 4, further comprising, prior to the reducing the dimensionality of two-dimensional spatial data in original data of a target number to obtain one-dimensional spatial data of the target number, receiving inquiry information inputted by a user, the inquiry information comprising an inquiry number and an inquiry time period, the quantity of the inquiry number being at least two (2), using one of the inquiry numbers as the target number, and using the rest of the inquiry numbers as the one or more other numbers.

10. The method of claim 9, further comprising, prior to the calculating an adjoint similarity between the target number and one or more other numbers based on the trajectory queue of the target number:
reducing the dimensionality of two-dimensional spatial data in original data of the potential numbers to obtain one-dimensional spatial data of the potential numbers;
generating trajectory records of the potential numbers by using the one-dimensional spatial data of the potential numbers and the time data in the original data; and
performing data normalization on the trajectory records of the potential numbers, to obtain trajectory queues of the potential numbers.

11. The method of claim 10, the calculating an adjoint similarity between the target number and one or more other numbers based on the trajectory queue of the target number comprising calculating, based on the preset adjoint similarity calculation strategy, the adjoint similarities between the target number and each of the one or more other numbers.

12. The method of claim 7, the calculating, based on the preset adjoint similarity calculation strategy, the adjoint similarities between the target number and each of the other numbers, comprising:
dividing the geohash encoding of the preset digits based on geography;
setting different weights for each level of the geohash encoding;
comparing each record in the trajectory queue of the target number with each record in the one or more other numbers;
determining whether intersections in time between two records being compared exist;
if it is determined that intersections in time exist, obtaining duplicate levels between the geohash encodings in the two records that are being compared;
obtaining intersection values according to the weights corresponding to the duplicate levels and a preset intersection base; and
adding all the intersection values and obtaining a ratio of a sum of all the intersection values to the number of intersections, and using the ratio as the adjoint similarity between the target number and the one or more other numbers.

13-24. (canceled)

25. An apparatus comprising:
a processor; and
a storage medium for tangibly storing thereon program logic for execution by the processor, the stored program logic comprising:
logic, executed by the processor, for reducing a dimensionality of two-dimensional spatial data in original data of a target number to obtain one-dimensional spatial data of the target number;
logic, executed by the processor, for converting the one-dimensional spatial data of the target number and time data into a comparable trajectory queue of the target number; and
logic, executed by the processor, for calculating an adjoint similarity between the target number and one or more other numbers based on the trajectory queue.

26. The apparatus of claim 25, the logic for reducing the dimensionality of two-dimensional spatial data in original data comprising logic, executed by the processor, for performing two-dimensional hashing on the two-dimensional spatial data in the original data to obtain a one-dimensional geohash encoding as the one-dimensional spatial data of the target number.

27. The apparatus of claim 25, the logic for converting the one-dimensional spatial data of the target number and time data comprising:
logic, executed by the processor, for generating a trajectory record of the target number through the one-dimensional spatial data and time data in the original data, the trajectory record of the target number configured to record locations of the target number at different time points, the time points corresponding to the time data in the original data, and the locations shown using the one-dimensional spatial data; and
logic, executed by the processor, for performing data normalization on the trajectory record of the target number to obtain the trajectory queue of the target number, the trajectory queue of the target number configured to record locations of the target number in different time periods, and the time periods generated using time points in the trajectory record of the target number.

28. The apparatus of claim 27, the logic for performing data normalization on the trajectory record of the target number to obtain the trajectory queue of the target number comprising:
for a record having continuous time points locating at the same location in the trajectory record of the target number, logic, executed by the processor, for using a time point showing the earliest time as a start time of the same location, and using a time point showing the latest time as an end time of the same location, to obtain a trajectory corresponding to the same location;
for a record having different time points locating at different locations in the trajectory record of the target number, logic, executed by the processor, for using the time points as start times and end times of the different locations to obtain trajectories corresponding to the different locations;
logic, executed by the processor, for sorting the trajectories of the target number from the earliest to the latest according to the start times;
logic, executed by the processor, for adjusting digits of the geohash encoding in each trajectory of the target number to preset digits; and
logic, executed by the processor, for adjusting endpoints of the time periods of adjacent trajectories of the target number so that the endpoints of the time periods of the adjacent trajectories overlap, to obtain the trajectory queue of the target number.

29. The apparatus of claim 28, the stored program logic further comprising logic, executed by the processor, for, prior to the performing a dimensionality reduction processing on original data of a target number to obtain dimensionality reduction data, receiving inquiry information inputted by a user, the inquiry information comprising an inquiry number and an inquiry time period, the quantity of the inquiry number being one, and the inquiry number being used as the target number.

30. The apparatus of claim 29, the stored program logic further comprising, prior to the calculating an adjoint similarity between the target number and one or more other numbers based on the trajectory queue of the target number:
logic, executed by the processor, for obtaining credible intervals of the target number according to the trajectory queue of the target number;
logic, executed by the processor, for obtaining, according to the credible interval, potential numbers having trajectory records similar to that of the target number;
logic, executed by the processor, for reducing the dimensionality of two-dimensional spatial data in original data of the potential numbers to obtain one-dimensional spatial data of the potential numbers;
logic, executed by the processor, for generating trajectory records of the potential numbers by using the one-dimensional spatial data of the potential numbers and the time data in the original data; and
logic, executed by the processor, for performing data normalization on the trajectory records of the potential numbers, to obtain trajectory queues of the potential numbers.

31. The apparatus of claim 30, the logic for calculating an adjoint similarity between the target number and one or more other numbers based on the trajectory queue of the target number comprising:
logic, executed by the processor, for using the potential numbers as the other numbers; and
logic, executed by the processor, for calculating, based on a preset adjoint similarity calculation strategy, the adjoint similarities between the target number and each of the other numbers.

32. The apparatus of claim 31, the stored program logic further comprising, after the calculating, based on a preset adjoint similarity calculation strategy, the adjoint similarities between the target number and each of the potential numbers, logic, executed by the processor, for sorting the adjoint similarities between the target number and each of the potential numbers to obtain an adjoint similarity list of the target number.

33. The apparatus of claim 28, the stored program logic further comprising, prior to the reducing the dimensionality of two-dimensional spatial data in original data of a target number to obtain one-dimensional spatial data of the target number, logic, executed by the processor, for receiving inquiry information inputted by a user, the inquiry information comprising an inquiry number and an inquiry time period, the quantity of the inquiry number being at least two (2), using one of the inquiry numbers as the target number, and using the rest of the inquiry numbers as the other numbers.

34. The apparatus of claim 33, the stored program logic further comprising, prior to the calculating an adjoint similarity between the target number and one or more other numbers based on the trajectory queue of the target number:
logic, executed by the processor, for reducing the dimensionality of two-dimensional spatial data in original data of the potential numbers to obtain one-dimensional spatial data of the potential numbers;
logic, executed by the processor, for generating trajectory records of the potential numbers by using the one-dimensional spatial data of the potential numbers and the time data in the original data; and
logic, executed by the processor, for performing data normalization on the trajectory records of the potential numbers, to obtain trajectory queues of the potential numbers.

35. The apparatus of claim 34, the logic for calculating an adjoint similarity between the target number and one or more other numbers based on the trajectory queue of the target number comprising logic, executed by the processor, for calculating, based on the preset adjoint similarity calculation strategy, the adjoint similarities between the target number and each of the other numbers.

36. The apparatus of claim 31, the logic for calculating, based on the preset adjoint similarity calculation strategy, the adjoint similarities between the target number and each of the other numbers, comprising:
logic, executed by the processor, for dividing the geohash encoding of the preset digits based on geography;
logic, executed by the processor, for setting different weights for each level of the geohash encoding;
logic, executed by the processor, for comparing each record in the trajectory queue of the target number with each record in the other numbers;
logic, executed by the processor, for determining whether intersections in time between two records being compared exist;
if it is determined that intersections in time exist, logic, executed by the processor, for obtaining duplicate levels between the geohash encodings in the two records that are being compared;
logic, executed by the processor, for obtaining intersection values according to the weights corresponding to the duplicate levels and a preset intersection base; and
logic, executed by the processor, for adding all the intersection values and obtaining a ratio of a sum of all the intersection values to the number of intersections, and using the ratio as the adjoint similarity between the target number and the other numbers.
